(19) United States
(12) Patent Application Publication
(10) Pub. No.: US 2026/0138870 A1
(43) Pub. Date: May 21, 2026

(54) LOW CARBON POWER GENERATION INTEGRATED WITH PARTIAL AMMONIA CRACKING

(71) Applicant: Chevron U.S.A. Inc., San Ramon, CA (US)

(72) Inventors: Daniel Chinn, Danville, CA (US); Yaofan Yi, Moraga, CA (US)

(21) Appl. No.: 18/951,000

(22) Filed: Nov. 18, 2024

(51) Int. Cl. C01B 3/04

(52) U.S. Cl. CPC C01B 3/047; C01B 2203/0415; C01B 2203/043; C01B 2203/0827; C01B 2203/0883; C01B 2203/1058; C01B 2203/146; C01B 2203/84

(57) ABSTRACT

A process for process for generating power in an ammonia-fueled gas turbine power plant includes flowing an ammonia feed stream to an ammonia cracker reactor in geographical proximity to an ammonia-fueled gas turbine power plant to crack ammonia feed stream under cracking conditions, thereby producing a product effluent comprising ammonia and hydrogen, flowing the product effluent comprising ammonia and hydrogen to an ammonia-fueled gas turbine of an ammonia-fueled gas turbine power plant, and combusting the product effluent comprising ammonia and hydrogen to drive the ammonia-fueled gas turbine. An exhaust gas stream generated from the ammonia-fueled gas turbine is recycled back to supply heat to the ammonia cracker reactor.

### BACKGROUND

Ammonia can be used as a source to produce low carbon hydrogen, in particular for the generation of electrical power in regions with few or no fuel sources. Also, ammonia is an effective hydrogen carrier since it contains 17.6 wt. % hydrogen and zero carbon. The advantage of ammonia as a hydrogen carrier or energy carrier is that liquid ammonia is easier to transport over longer distances and to store than, for example, liquefied hydrogen or compressed hydrogen gas. Additionally, storing energy in ammonia is less expensive than, for example, in hydrogen or batteries.

To use ammonia as a hydrogen carrier, ammonia can be cracked/decomposed into hydrogen and nitrogen. For example, ammonia cracking is an endothermic reaction that requires a catalyst and high temperature: 2NH₃→3H₂+N₂. The unconverted ammonia may be recovered using a water wash and distillation process, while hydrogen purification can be done by pressure swing adsorption (PSA). The decomposed ammonia can be fed to a gas turbine, while high-purity hydrogen can be recovered for fuel cells or other use. Due to energy loss during ammonia cracking, it's preferable to minimize cracking need and maximize direct use of ammonia as hydrogen carrier.

### SUMMARY

In accordance with an illustrative embodiment, a process for generating power in an ammonia-fueled gas turbine power plant comprises:
flowing an ammonia feed stream to an ammonia cracker reactor in geographical proximity to an ammonia-fueled gas turbine power plant to partially crack ammonia feed stream under cracking conditions, thereby producing a product effluent comprising ammonia and hydrogen,
flowing the product effluent comprising ammonia and hydrogen to an ammonia-fueled gas turbine comprising a compressor, a combustor and a turbine of an ammonia-fueled gas turbine power plant, and
combusting the product effluent comprising ammonia and hydrogen to drive the ammonia-fueled gas turbine,
wherein an exhaust gas stream generated from the ammonia-fueled gas turbine is recycled back to supply heat to the ammonia cracker reactor.

In accordance with another illustrative embodiment, a process for generating power in an ammonia-fueled gas turbine power plant comprises:
flowing an ammonia gas feed stream to an ammonia cracker reactor in geographical proximity to an ammonia-fueled gas turbine power plant to crack ammonia feed stream under cracking conditions, thereby producing a product effluent comprising ammonia and hydrogen,
flowing a liquid ammonia feed stream to a vaporizer to produce a vapor comprising ammonia gas,
introducing the product effluent comprising ammonia and hydrogen into a water wash column, thereby producing a hydrogen-enriched gas effluent and an ammonia-enriched effluent comprising ammonia and water,
introducing the ammonia-enriched effluent into a distillation column, thereby producing a cleaned water wash stream and an ammonia gas,
introducing the hydrogen-enriched effluent to a pressure swing adsorption unit, thereby producing a high-purity hydrogen gas,
combining the vapor comprising ammonia gas, the ammonia gas and the high-purity hydrogen gas, thereby producing a product gas comprising from about 50 vol. % to about 75 vol. % ammonia gas and from about 25 vol. % to about 50 vol. % high-purity hydrogen gas, and
combusting the product gas in an ammonia-fueled gas turbine to drive the ammonia-fueled gas turbine for providing power to the ammonia-fueled gas turbine power plant.

In accordance with yet another illustrative embodiment, a system comprises:
an ammonia cracker reactor in geographical proximity to an ammonia-fueled gas turbine power plant configured to crack an ammonia feed stream under cracking conditions, thereby producing a product effluent comprising ammonia and hydrogen,
an ammonia-fueled gas turbine comprising a compressor, a combustor and a turbine of the ammonia-fueled gas turbine power plant and configured to combust the product effluent comprising ammonia and hydrogen and drive the ammonia-fueled gas turbine, and
a recycle line configured to flow an exhaust gas stream generated from the ammonia-fueled gas turbine back to supply heat to the ammonia cracker reactor.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. In the accompanying drawings:

FIG. 1 illustrates a schematic diagram of a process and system for integrating partial ammonia cracking with low carbon power generation, according to an illustrative embodiment.

FIG. 2A illustrates a schematic diagram of a process and system for integrating partial ammonia cracking with low carbon power generation in a simple cycle power facility, according to an illustrative embodiment.

FIG. 2B illustrates a schematic diagram of a simple cycle gas turbine for use in the simple cycle power facility of FIG. 2A, according to an illustrative embodiment.

FIG. 3A illustrates a schematic diagram of a process and system for integrating partial ammonia cracking with low carbon power generation in a combined cycle power facility, according to an illustrative embodiment.

FIG. 3B illustrates a schematic diagram of a combined cycle gas turbine for use in the combined cycle power facility of FIG. 3A, according to an illustrative embodiment.

### DETAILED DESCRIPTION

Various illustrative embodiments described herein are directed to processes and systems for integrating partial ammonia cracking with low carbon power generation.

As mentioned above, ammonia is regarded as a hydrogen carrier that is easier to transport over long distances. To use ammonia as a hydrogen carrier, ammonia can be cracked/decomposed into hydrogen and nitrogen. For example, ammonia cracking is an endothermic reaction that requires a catalyst and high temperature: 2NH₃→3H₂+N₂. The decomposed ammonia can be fed to a gas turbine while high-purity hydrogen can be recovered for fuel cells or other use.

The combustion of pure ammonia is problematic due to low flame speeds and low firing temperature, while combustion of pure hydrogen has the opposite problem of excess flame speeds. A power plant can often incorporate combustion of ammonia and hydrogen by blending them with natural gas. However, the main disadvantage is that there will still be direct carbon dioxide emissions and indirect, embedded emissions associated with the natural gas.

The illustrative embodiments described herein overcome these and other drawbacks by providing processes and systems for integrating a partial ammonia cracker reactor with a power plant for low carbon power generation. Among other factors, it has been found that the combined power plant and ammonia cracker reactor does not have to use any natural gas and is self-sufficient in terms of power generation. The only potential emissions are nitrogen oxides (NOₓ) and indirect, embedded emissions associated with ammonia. By partially cracking ammonia, the ammonia cracker reactor can produce any suitable ammonia/hydrogen blend to obtain the desired hydrogen and ammonia levels for sending to an ammonia-fueled gas turbine to provide power to the power plant.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

The term “zone” can refer to an area including one or more equipment items and/or one or more sub-zones. Equipment items can include one or more reactors or reactor vessels, absorption units, separation vessels, distillation towers, heaters, heat exchangers, pipes, pumps, compressors, and controllers. Additionally, an equipment item, such as a reactor, dryer, or vessel, can further include one or more zones or sub-zones.

The term “effluent” refers to a stream that is passed out of a reactor, a reaction zone, or a separation unit following a particular reaction or separation. Generally, an effluent has a different composition than the stream that entered the reactor, reaction zone, or absorption unit. It should be understood that when an effluent is passed to another component or system, only a portion of that effluent may be passed. For example, a slipstream may carry some of the effluent away, meaning that only a portion of the effluent may enter the downstream component or system.

The terms “wt. %”, “vol. %” or “mol. %” refers to a weight, volume, or molar percentage of a component, respectively, based on the total weight, the total volume, or the total moles of material that includes the component. In a non-limiting example, 10 moles of component in 100 moles of the material are 10 mol. % of component.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

Although any processes and materials similar or equivalent to those described herein can be used in the practice or testing of the illustrative embodiments described herein, the typical processes and materials are herein described.

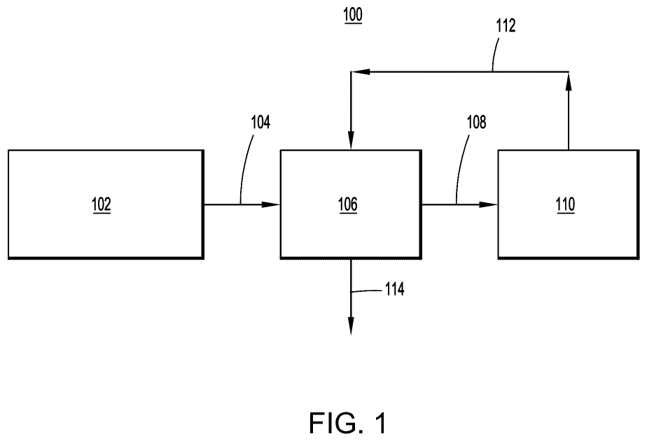

The non-limiting illustrative embodiments of the present disclosure are directed to systems and processes for integrating a partial ammonia cracker reactor with a power plant for low carbon power generation. The non-limiting illustrative embodiments of the present disclosure will be specifically described below with reference to the accompanying drawings. For the purpose of clarity, some steps leading up to the integrating partial ammonia cracking with low carbon power generation as illustrated in FIGS. 1-3B are omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

Referring now to the drawings in more detail, FIG. 1 illustrate a system including an ammonia storage unit, an ammonia cracker reactor and a power plant. It is to be understood that the system including the ammonia storage unit, the ammonia cracker reactor and the power plant is not limited to the configuration of the embodiments shown in FIG. 1, and other configurations are contemplated herein. For case of understanding, specific examples mentioned in the following description are all illustrative and are not used to limit the protection scope of the present disclosure.

FIG. 1 show a system 100 including an ammonia storage unit 102 for storing ammonia, an ammonia cracker reactor 106 for cracking ammonia and a power plant 108. Ammonia storage unit 102 can be any conventional storage unit for storing ammonia. In some embodiments, ammonia can be stored in ammonia storage unit 102 as a refrigerated fluid or at ambient temperature.

An ammonia feed stream 104 comprising ammonia is sent from ammonia storage unit 102 to ammonia cracker reactor 106. In some embodiments, ammonia feed stream 104 can first be passed to a pump to increase the pressure of ammonia feed stream 104 for sending to ammonia cracker reactor 106 (not shown). In some embodiments, ammonia feed stream 104 can be pre-heated using any suitable heating source such as, for example, an electric heater, heat exchanger, etc., for sending to ammonia cracker reactor 106.

In some embodiments, ammonia feed stream 104 can be passed to a vaporizer to vaporize the liquid ammonia (not shown). For example, the vaporizer can be a heat exchanger that performs heat exchange between warm water and the liquid ammonia to heat and vaporize the liquid ammonia. The vaporizer can have a heat transfer tube through which the warm water flows, and a vaporizer casing that covers the heat transfer tube and temporarily stores the liquid ammonia. The vaporizer can have a gaseous ammonia line with a regulating valve that regulates the flow rate of the gaseous ammonia flowing into ammonia cracker reactor 106.

Ammonia cracker reactor 106 can be any suitable ammonia cracker reactor 106. Suitable ammonia cracker reactors for ammonia cracker reactor 106 are well-known to those of skill in the art. In some embodiments, heat is inputted into ammonia cracker reactor 106 using, for example, a suitable heating unit such as a furnace or an electric heater with a suitable heat source. In some embodiments, heat is inputted into ammonia cracker reactor 106 using, for example, a suitable heat source such as, for example, a tail gas stream composed of H₂, N₂, and trace NH₃ from a pressure swing adsorption (PSA) process, slipstream of ammonia feedstock from ammonia storage unit 102, and flash gases from the ammonia recovery/water wash process as discussed below. In some embodiments, flash gases from the ammonia recovery/water wash process can have a temperature ranging from about 40° C. to about 60° C.

In some embodiments, heat is inputted into ammonia cracker reactor 106 using, for example, an exhaust gas stream 112 generated from an ammonia-fueled gas turbine in an ammonia-fueled gas turbine power plant 110 as discussed below. For example, in some embodiments, exhaust gas stream 112 can be at a temperature ranging from about 800° C. to about 900° C. As one skilled in the art will readily appreciate, in order to ensure that there is enough pressure to flow exhaust gas stream 112 from the ammonia-fueled gas turbine to ammonia cracker reactor 106, and back out again, the pressure of exhaust gas stream 112 will be sufficiently high as set by the exhaust pressure of the ammonia-fueled gas turbine.

The ammonia cracking can be carried out using any ammonia-cracking catalyst. In some embodiments, suitable ammonia-cracking catalysts include, for example, a bi-metallic transition metal catalyst, or a light metal amide/imide catalyst. In some embodiments, suitable ammonia-cracking catalysts include, for example nickel supported on aluminum oxide, ruthenium on aluminum oxide, and iron on silicon dioxide.

Suitable cracking conditions include, by way of example, a temperature ranging from about 400° C. to about 950° C., or from about 450° C. to about 700° C., and a pressure ranging from about 1 bar to about 50 bar, or from about 4 bar to about 40 bar.

Ammonia cracker reactor 106 can be designed to provide any suitable blend of ammonia, nitrogen and hydrogen. In some embodiments, ammonia feed stream 104 is passed to a cracking zone in ammonia cracker reactor 106 for partial cracking into hydrogen and nitrogen to generate a product gas effluent 108 composed of ammonia, hydrogen and optionally nitrogen. Thus, the cracking is incomplete such that only a portion of the ammonia entering ammonia cracker reactor 106 is cracked into hydrogen and nitrogen to meet the desired specifications for being passed to an ammonia-fueled gas turbine in ammonia-fueled gas turbine power plant 110 as discussed below. For example, by forming product gas effluent 108 having the desired ratio of hydrogen and ammonia, product gas effluent 108 would burn similarly in an ammonia-fueled gas turbine as compared to 100% natural gas in a natural gas-fueled gas turbine, while also allowing the power plant to lower its carbon emissions without having to greatly modify the combustion equipment/turbines. Thus, the ammonia-fueled gas turbine in the ammonia-fueled power plant would be a retrofit of a natural gas-fueled gas turbine in a natural gas-fueled power plant.

In some embodiments, a desired ratio includes product gas effluent 108 containing from about 25 vol. % to about 50 vol. % hydrogen and from about 50 vol. % to about 75 vol. % ammonia. In some embodiments, product gas effluent 108 can contain from about 30 vol. % to about 50 vol. % hydrogen and from about 50 vol. % to about 70 vol. % ammonia. In some embodiments, product gas effluent 108 can contain about 30 vol. % hydrogen and about 70 vol. % ammonia. In some embodiments, product gas effluent 108 can contain from about 5 vol. % to about 10 vol. % nitrogen. In some embodiments, product gas effluent 108 can contain no nitrogen.

System 100 further includes ammonia-fueled gas turbine power plant 110 in geographical proximity to ammonia cracker reactor 106. In some embodiments, ammonia cracker reactor 106 can be located within ammonia-fueled gas turbine power plant 110. In some embodiments, ammonia cracker reactor 106 can be located in relatively close proximity to ammonia-fueled gas turbine power plant 110. For example, ammonia cracker reactor 106 can be located less than about 100 miles, or less than about 75 miles, or less than about 50 miles, or less than about 25 miles, or less than about 15 miles, or less than about 10 miles or less than about 5 miles to ammonia-fueled gas turbine power plant 110. Accordingly, as one skilled in the art will appreciate, one or more pipelines can be employed to transport product gas effluent 108 from ammonia cracker reactor 106 to ammonia-fueled gas turbine power plant 110, and one or more other pipelines can be employed to transport exhaust gas stream 112 from ammonia-fueled gas turbine power plant 110 to ammonia cracker reactor 106.

Ammonia-fueled gas turbine power plant 110 produces electricity utilizing one or more ammonia-fueled gas turbines as a kinetic energy source to drive electricity generators. In some instances, electric power to drive an apparatus can be supplied from at least one ammonia-fueled gas turbine provided as a separate installation or within, for example a cogeneration facility and/or a combined cycle power facility or a simple cycle power facility, using product gas effluent 108 as a fuel.

Ammonia-fueled gas turbine power plant 110 includes at least an ammonia-fueled gas turbine for receiving product gas effluent 108 from ammonia cracker reactor 106. In some embodiments, the ammonia-fueled gas turbine includes a compressor that compresses air, a combustor that burns fuel in the air compressed by the compressor to generate a combustion gas, and a turbine that is driven by the high-temperature and high-pressure combustion gas.

In some embodiments, the compressor includes a compressor rotor that rotates with a rotor axis as a center, a compressor casing that covers the compressor rotor, and an intake air amount regulator provided in a suction port of the compressor casing. The intake air amount regulator regulates the flow rate of air that is sucked into the compressor casing according to an instruction from a control device. In some embodiments, the turbine has a turbine rotor that rotates with the rotor axis as a center by means of the combustion gas from the compressor, and a turbine casing that covers the turbine rotor. The turbine rotor and the compressor rotor can be connected to each other to be rotatable with the same rotor axis as a center to form a gas turbine rotor. For example, a rotor of a generator is connected to the gas turbine rotor.

In some embodiments, the compressor is, for example, an axial-flow compressor that includes moving blades and stationary blades which are disposed alternately in multiple stages along a rotating shaft, and pressurizes air taken from the atmosphere to a predetermined pressure and supplies it to the combustor. The rotating shaft of the compressor can be axially coupled to a rotating shaft of the turbine and is rotated by the turbine.

In some embodiments, the combustor has a burner that injects compressed air supplied from the compressor and product gas effluent 108 as fuel supplied from ammonia cracker reactor 106 into a chamber, and combusts product gas effluent 108 using the compressed air as an oxidant. The combustor supplies the turbine with a high-temperature and high-pressure combustion gas generated through a combustion reaction of product gas effluent 108 as a driving fluid.

In some embodiments, the turbine is, for example, an axial-flow turbine that includes moving blades and stationary blades which are disposed alternately in multiple stages along a rotating shaft, and is a prime mover that converts kinetic energy of the combustion gas (driving fluid) into power. The turbine rotates the compressor to which the rotating shaft is axially coupled by the power generated by the turbine itself. Also, the turbine can include an output shaft that is connected to a load and rotates the load.

In some embodiments, exhaust gas stream 112 from the ammonia-fueled gas turbine exhaust in ammonia-fueled gas turbine power plant 110 can be recycled back to heat ammonia cracker reactor 106 as a heat source for cracking ammonia feed stream 104 and/or to heat the vaporizer as discussed above. For example, exhaust gas stream 112 can enter ammonia cracker reactor 106 as a heat source for cracking ammonia feed stream 104, and thereafter exits ammonia cracker reactor 106 as a cooled exhaust gas stream 114 at a reduced temperature as compared to exhaust gas stream 112. In some embodiments, exhaust gas stream 112 can be at a temperature ranging from about 800° C. to about 900° C. In some embodiments, exhaust gas stream 112 is composed of nitrogen, oxygen and water. In some embodiments, exhaust gas stream 112 comprises about 10 vol. % to about 11 vol. % oxygen and about 13 vol. % to about 15 vol. % water. In some embodiments, cooled exhaust gas stream 114 can exit ammonia cracker reactor 106 at a temperature ranging from about 715° C. to about 750° C.

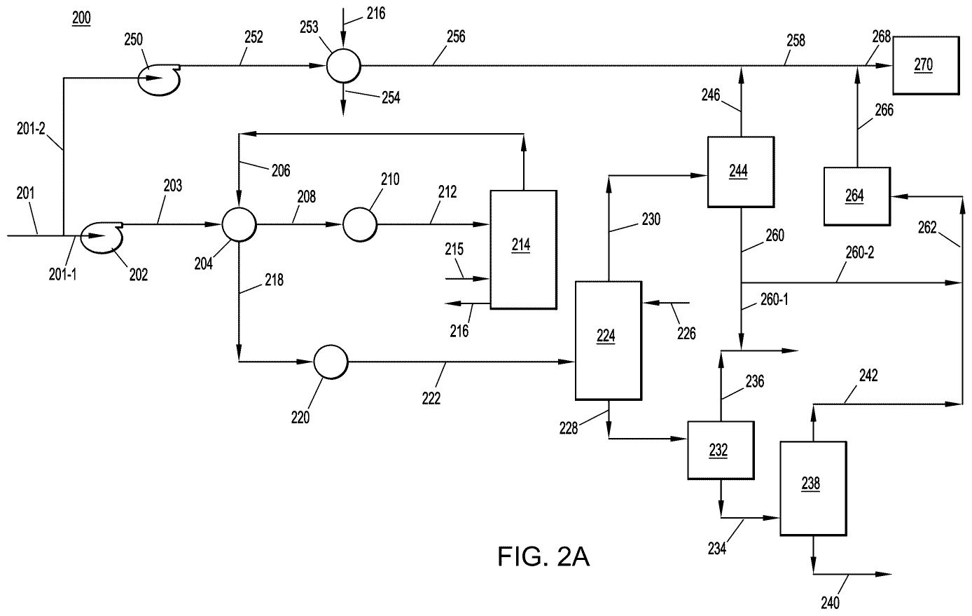

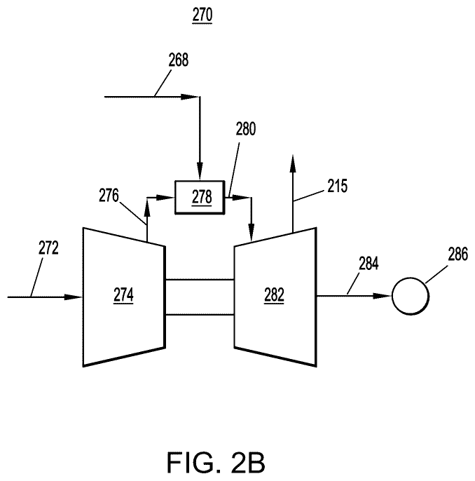

In accordance with a non-limiting illustrative embodiment of the present disclosure, FIG. 2A illustrates a schematic diagram of a system 200 for integrating partial ammonia cracking with low carbon power generation from an ammonia-fueled gas turbine engine in a simple cycle power facility using the exhaust gas generated from the ammonia-fueled gas turbine engine as a heat source for the different components in system 200 (e.g., the ammonia cracker reactor, vaporizers, etc.)

System 200 includes an ammonia feed stream 201 comprising ammonia received from, for example, an ammonia storage unit as discussed above. Ammonia feed stream 201 can be a refrigerated fluid or at ambient temperature. Ammonia feed stream 201 is split into a first ammonia feed stream 201-1 and a second ammonia feed stream 201-2. First ammonia feed stream 201-1 is passed to a pump 202 for increasing the pressure of first ammonia feed stream 201-1. Pump 202 can be any suitable pump for increasing the pressure of first ammonia feed stream 201-1 for sending a pressurized first ammonia feed stream 203 to a heat exchanger 204. For example, pump 202 may be a centrifugal pump, a rotary pump including an impeller, or alternatively may be any other suitable fluid pump.

System 200 further includes heat exchanger 204 for receiving pressurized first ammonia feed stream 203 at or around room temperature, i.e., about 20° C., and a heated product gas effluent 206 from an ammonia cracker reactor 214 as discussed below as a heat transfer medium to generate a heated first ammonia feed stream 208 and a first cooled product gas effluent 218. In some embodiments, heat exchanger 204 may be a shell-and-tube, plate-fin, microchannel, spiral wound, or any other suitable heat exchanger.

System 200 further includes an ammonia vaporizer 210 for receiving heated first ammonia feed stream 208. Ammonia vaporizer 210 can be any suitable ammonia vaporizer that can vaporize heated first ammonia feed stream 208 to produce an ammonia gas 212. For example, ammonia vaporizer 210 can be a heat exchanger that performs heat exchange between warm water and heated first ammonia feed stream 208 to further heat and vaporize heated first ammonia feed stream 208 to generate an ammonia gas 212. In some embodiments, ammonia vaporizer 210 can have a heat transfer tube through which the warm water flows, and a vaporizer casing that covers the heat transfer tube and temporarily stores heated first ammonia feed stream 208. Ammonia vaporizer 210 can have a gaseous ammonia line with a regulating valve that regulates the flow rate of ammonia gas 212 into ammonia cracker reactor 214. As another example, ammonia vaporizer 210 may mix heated first ammonia feed stream 208 with hot air, vaporize heated first ammonia feed stream 208, and then pump ammonia gas 212 directly to ammonia cracker reactor 214.

System 200 further includes ammonia cracker reactor 214 for receiving ammonia gas 212 and an exhaust gas stream 215 from an ammonia-fueled gas turbine 270 as discussed below. Ammonia cracker reactor 214 is in geographical proximity to a simple cycle power facility 286 (i.e., an ammonia-fueled gas turbine power plant) (see FIG. 2B). The geographical proximity is similar to that discussed above for ammonia-fueled gas turbine power plant 110 in geographical proximity to ammonia cracker reactor 106 with regard to FIG. 1. Exhaust gas stream 215 enters ammonia cracker reactor 214 as a heat source for partial cracking of ammonia gas 212 into hydrogen and nitrogen to generate heated product gas effluent 206 composed of ammonia, hydrogen and optionally nitrogen.

Heated product gas effluent 206 can be formed using similar cracking catalysts and cracking conditions as discussed above. The partial cracking of ammonia gas 212 is incomplete such that only a portion of ammonia gas 212 entering ammonia cracker reactor 214 is cracked into hydrogen and nitrogen. The particular blends of ammonia and hydrogen formed by the partial cracking of ammonia gas 212 can vary widely depending on the cracking catalyst, reaction conditions, ammonia cracker reactor, etc. Accordingly, in order to meet the desired specifications for a product gas stream 268 composed of ammonia, hydrogen and optionally nitrogen to be passed to an ammonia-fueled gas turbine 270 to generate sufficient power to operate simple cycle power facility 286 (see FIG. 2B), it may be necessary to modify the amounts of ammonia and hydrogen present in heated product gas effluent 206. For example, in the case where heated product gas effluent 206 contains an amount of hydrogen below the desired specification, i.e., less than about 25 vol. % hydrogen, heated product gas effluent 206 will have to be modified to increase the amount of hydrogen so that product gas stream 268 meets the desired specification. Alternatively, in the case where heated product gas effluent 206 contains an amount of ammonia below the desired specification, i.e., less than 50 vol. % ammonia, heated product gas effluent 206 will have to be modified to increase the amount of ammonia so that product gas stream 268 meets the desired specification. This is accomplished by the non-limiting illustrative embodiments described herein for system 200 for integrating partial ammonia cracking with low carbon power generation in a simple cycle power facility.

In some embodiments, exhaust gas stream 215 can be at a temperature ranging from about 800° C. to about 900° C. In some embodiments, exhaust gas stream 215 is composed of nitrogen, oxygen and water. In some embodiments, exhaust gas stream 215 comprises about 10 vol. % to about 11 vol. % oxygen and about 13 vol. % to about 15 vol. % water. In some embodiments, exhaust gas stream 215 is first compressed to produce a compressed exhaust gas stream and then compressed tail gas stream is passed to ammonia cracker reactor 214.

Following the partial cracking of ammonia gas 212, an exhaust gas stream 216 exits ammonia cracker reactor 214 at a temperature lower than exhaust gas stream 215, e.g., at a temperature ranging from about 715° C. to about 750° C. Exhaust gas stream 216 can be sent to an ammonia vaporizer 253 as discussed below.

Ammonia-fueled gas turbine 270 can be any suitable gas turbine fueled by ammonia for a simple cycle power plant. In an illustrative embodiment, FIG. 2B shows an example of ammonia-fueled gas turbine 270 for use in system 200. Ammonia-fueled gas turbine 270 includes a compressor 274 for compressing an oxidizing agent stream 272 to send a compressed oxidizing agent stream 276 to a combustion unit 278. Oxidizing agent stream 272 can be any suitable oxidizing source for combusting product gas stream 268 as discussed below. In an illustrative embodiment, the oxidizing source can be air, oxygen, or oxygen diluted with carbon dioxide (i.e., an oxygen enriched source).

In some embodiments, compressor 274 includes a compressor rotor that rotates with a rotor axis as a center, a compressor casing that covers the compressor rotor, and an intake air amount regulator provided in a suction port of the compressor casing. The intake air amount regulator regulates the flow rate of air that is sucked into compressor 274 casing according to an instruction from a control device. In some embodiments, compressor 274 is, for example, an axial-flow compressor that includes moving blades and stationary blades which are disposed alternately in multiple stages along a rotating shaft, and pressurizes air taken from the atmosphere to a predetermined pressure and supplies it to the combustor. The rotating shaft of compressor 274 can be axially coupled to a rotating shaft of a turbine 282 and is rotated by turbine 282.

Ammonia-fueled gas turbine 270 includes combustion unit 278 for combusting product gas stream 268 using compressed oxidizing agent stream 276. Product gas stream 268 can be composed of a blend of hydrogen and ammonia as a fuel for operating ammonia-fueled gas turbine 270 to generate power to operate simple cycle power facility 286 as discussed below. Combustion unit 278 can be any combustion unit wherein a source of ammonia and hydrogen can be combusted with an oxidizing agent. For example, combustion unit 278 can be a fired heater or boiler used in power plants. In operation, combustion unit 278 can have burner that injects compressed oxidizing agent stream 276 supplied from compressor 274 and product gas stream 268 as a fuel into a chamber, and combusts product gas stream 268 using compressed oxidizing agent stream 276 as an oxidant.

Combustion unit 278 then supplies turbine 282 with a high-temperature and high-pressure combustion gas 280 (referred to combustion gas 280) as generated through a combustion reaction of product gas stream 268 as a driving fluid to generate an energy source 284 for providing power to simple cycle power facility 286 (i.e., an ammonia-fueled gas turbine power plant).

In some embodiments, turbine 282 has a turbine rotor that rotates with the rotor axis as a center by means of combustion gas 280 from combustion unit 278, and a turbine casing that covers the turbine rotor. The turbine rotor and the compressor rotor can be connected to each other to be rotatable with the same rotor axis as a center to form a gas turbine rotor. For example, a rotor of a generator is connected to the gas turbine rotor.

In some embodiments, turbine 282 can be, for example, an axial-flow turbine that includes moving blades and stationary blades which are disposed alternately in multiple stages along a rotating shaft, and is a prime mover that converts kinetic energy of the combustion gas (driving fluid) into power. In some embodiments, the turbine rotates compressor 274 to which the rotating shaft is axially coupled by the power generated by turbine 282 itself. Also, turbine 282 can include an output shaft that is connected to a load and rotates the load.

Simple cycle power facility 286 produces electricity utilizing energy source 284 from ammonia-fueled gas turbine 270 to drive, for example, electricity generators. Ammonia-fueled gas turbine 270 also produces exhaust gas stream 215 that can be recycled back to ammonia cracker reactor 214 and used as a heat source as discussed above. Thus, system 200 can operate in a continuous manner.

Turning back to FIG. 2A, as discussed above, first cooled product gas effluent 218 exits heat exchanger 204 and is then passed to a heat exchanger 220 to further reduce the temperature of first cooled product gas effluent 218. Heat exchanger 220 can be any suitable heat exchanger for further cooling first cooled product gas effluent 218. For example, in order for first cooled product gas effluent 218 to undergo further processing as discussed below, the temperature of first cooled product gas effluent 218 should be at or around room temperature. Thus, a suitable cooling medium such as water can be passed through heat exchanger 220 to further cool first cooled product gas effluent 218 to provide a second cooled product gas effluent 222. In some embodiments, heat exchanger 220 may be a shell-and-tube, plate-fin, microchannel, spiral wound, or any other suitable heat exchanger.

Second cooled product gas effluent 222 comprising hydrogen, ammonia and optionally nitrogen can then be passed to a water wash column 224. Water wash column 224 is configured to remove unreacted ammonia gas from the dry gas mixture by using, for example, a pressurized water stream 226, to generate an ammonia-enriched effluent 228 composed of ammonia and water and minor amounts of hydrogen and optionally nitrogen, and a hydrogen-enriched gas effluent 230 composed of hydrogen and optionally nitrogen. In some embodiments, pressurized water stream 226 can be sourced from a boiler feed water. As ammonia is very soluble in water, water wash column 224 can be designed to reduce the ammonia content in hydrogen-enriched gas effluent 230 to a level below, for example, 100 ppm, or below 20 ppm and allow feeding hydrogen-enriched gas effluent 230 comprised of hydrogen and optionally nitrogen to a pressure swing adsorption (PSA) unit 244.

In some embodiments, PSA unit 244 can include one or more adsorption beds for separating hydrogen from hydrogen-enriched gas effluent 230 to generate a high-purity hydrogen gas 246 having a purity of greater than about 95% and a PSA tail gas 260. In some embodiments, high-purity hydrogen gas 246 can have a nitrogen content of about 0.01 vol. % to about 5 vol. %. PSA tail gas 260 is comprised of nitrogen and any unrecovered hydrogen and some trace amounts of ammonia. In some embodiments, PSA unit 244 can include an adsorbent material comprised of carbon, silica, zeolites, metal organic frameworks, or combinations thereof. The working principle of a PSA unit such as PSA unit 244 may be understood as follows: a PSA unit comprises a physical separation process that allows small molecules, e.g., hydrogen, to pass through while trapping larger molecules (the adsorbate).

In some embodiments, PSA tail gas 260 is split into a first PSA tail gas 260-1 and a second PSA tail gas 260-2 as discussed below.

System 200 further includes a flash unit 232 for receiving ammonia-enriched effluent 228 from water wash column 224. Flash unit 232 is configured to generate a flash gas stream 236 composed of hydrogen and nitrogen from ammonia-enriched effluent 228 to provide an ammonia-enriched liquid 234 composed of ammonia and water, and a flash gas stream 236. Flash gas stream 236 exits flash unit 232 and can be combined with first PSA tail gas 260-1 as a fuel gas for, for example, a reboiler or a vaporizer in system 200.

System 200 further includes a separation unit 238 for separating the ammonia from water in ammonia-enriched liquid 234. In some embodiments, separation unit 238 can be a distillation unit configured to carry out a process of separating ammonia from water based on differences in their boiling temperatures. For example, the distillation unit can heat ammonia-enriched liquid 234 to a temperature sufficient to vaporize the ammonia in ammonia-enriched liquid 234 to generate an ammonia gas stream 242 and a water stream 240. In some embodiments, water stream 240 can be sent to a cooling tower or recycled back to system 200.

Ammonia gas stream 242 can be combined with second PSA tail gas 260-2 to form an ammonia gas and PSA tail gas 262. Ammonia gas and PSA tail gas 262 is passed to a compressor 264 for compressing ammonia gas and PSA tail gas 262 to form a compressed stream 266.

System 200 further includes a pump 250 for increasing the pressure of second ammonia feed stream 201-2. Pump 250 can be any suitable pump for increasing the pressure of second ammonia feed stream 201-2 for sending a pressurized second ammonia feed stream 252 to an ammonia vaporizer 253. For example, pump 250 may be a centrifugal pump, a rotary pump including an impeller, or alternatively may be any other suitable fluid pump.

System 200 further includes ammonia vaporizer 253 for receiving pressurized second ammonia feed stream 252. Ammonia vaporizer 253 can be any suitable ammonia vaporizer that can vaporize pressurized second ammonia feed stream 252 to produce an ammonia gas 256. For example, ammonia vaporizer 253 may mix pressurized second ammonia feed stream 252 with exhaust gas stream 216 from ammonia cracker reactor 214 and vaporize pressurized second ammonia feed stream 252 to generate ammonia gas 256 and an exhaust gas stream 254. Exhaust gas stream 254 can have a temperature lower than the temperature of exhaust gas stream 216, e.g., a temperature of about 690° C. to about 710° C.

Ammonia gas 256 is thereafter combined with high-purity hydrogen gas 246 and compressed stream 266 to form product gas stream 268 for sending to ammonia-fueled gas turbine 270. As discussed above, in order to meet the desired specifications for product gas stream 268 composed of ammonia, hydrogen and optionally nitrogen to be passed to ammonia-fueled gas turbine 270 to generate sufficient power to operate simple cycle power facility 286 (see FIG. 2B), it may be necessary to modify the amounts of ammonia and hydrogen present in heated product gas effluent 206 generated in ammonia cracker reactor 214.

Accordingly, the amount of ammonia gas 256, high-purity hydrogen gas 246 and compressed stream 266 will vary such that product gas stream 268 will meet the desired specifications for product gas stream 268 to be passed to ammonia-fueled gas turbine 270 to generate sufficient power to operate simple cycle power facility 286. In some embodiments, product gas stream 268 can contain from about 25 vol. % to about 50 vol. % hydrogen and from about 50 vol. % to about 75 vol. % ammonia. In some embodiments, product gas stream 268 can contain from about 30 vol. % to about 50 vol. % hydrogen and from about 50 vol. % to about 70 vol. % ammonia. In some embodiments, product gas stream 268 can contain about 30 vol. % hydrogen and about 70 vol. % ammonia. In some embodiments, product gas stream 268 can contain from about 5 vol. % to about 10 vol. % nitrogen. In some embodiments, product gas stream 268 can contain no nitrogen.

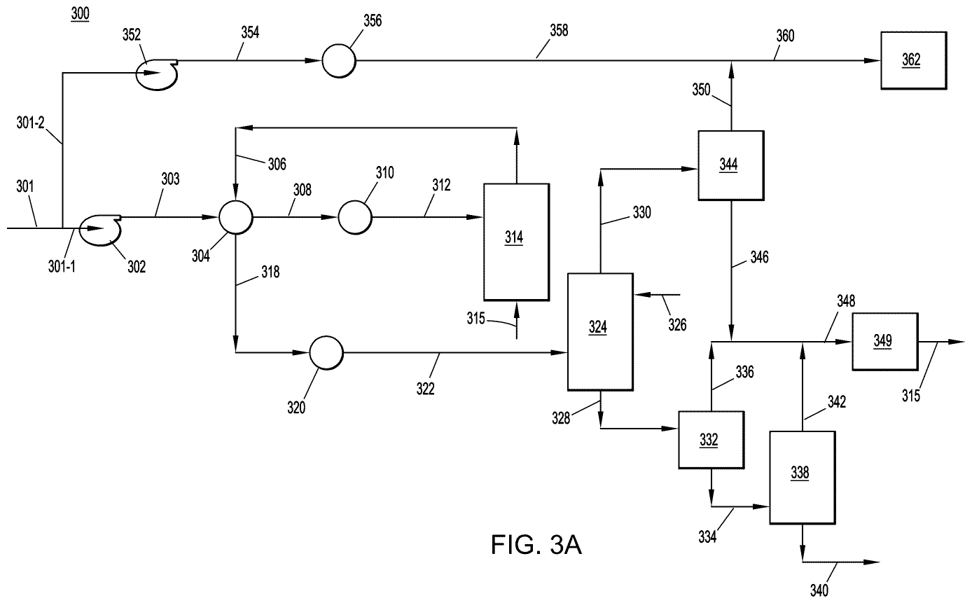

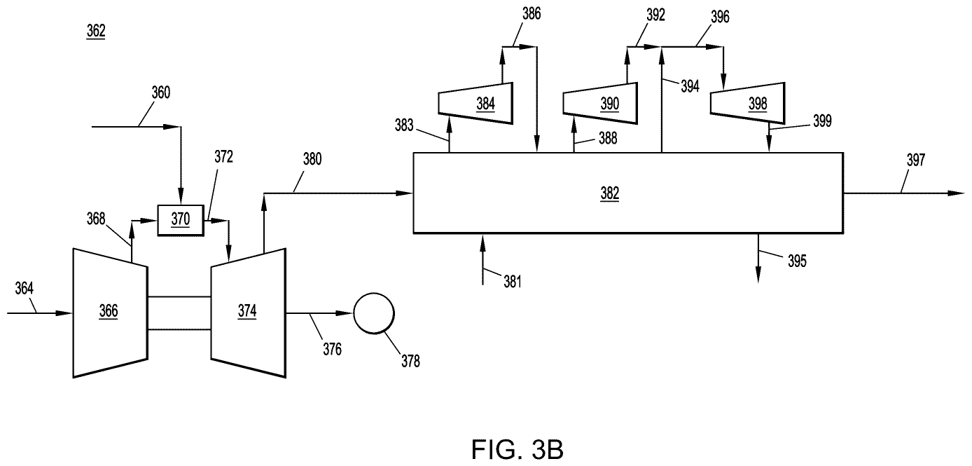

In accordance with a non-limiting illustrative embodiment of the present disclosure, FIG. 3A illustrates a schematic diagram of a system 300 for integrating partial ammonia cracking with low carbon power generation from an ammonia-fueled gas turbine engine in a combined cycle power facility using a fuel gas generated from a flash gas, PSA tail gas and ammonia gas as a heat source for the different components in system 300 (e.g., the ammonia cracker reactor, vaporizers, etc.).

System 300 includes an ammonia feed stream 301 comprising ammonia received from, for example, an ammonia storage unit as discussed above. Ammonia feed stream 301 can be a refrigerated fluid or at ambient temperature. Ammonia feed stream 301 is split into a first ammonia feed stream 301-1 and a second ammonia feed stream 301-2. First ammonia feed stream 301-1 is passed to a pump 302 for increasing the pressure of first ammonia feed stream 301-1. Pump 302 can be any suitable pump for increasing the pressure of first ammonia feed stream 301-1 for sending a pressurized first ammonia feed stream 303 to a heat exchanger 304. For example, pump 302 may be any of the pumps described above for pump 202.

System 300 further includes heat exchanger 304 for receiving pressurized first ammonia feed stream 303 at or around room temperature, i.e., about 20° C., and a heated product gas effluent 306 from an ammonia cracker reactor 314 as discussed below as a heat transfer medium to generate a heated first ammonia feed stream 308 and a first cooled product gas effluent 318. In some embodiments, heat exchanger 304 may be any of the heat exchangers described above for heat exchanger 204.

System 300 further includes an ammonia vaporizer 310 for receiving heated first ammonia feed stream 308. Ammonia vaporizer 310 can be any suitable ammonia vaporizer as described above for ammonia vaporizer 210 that can vaporize heated first ammonia feed stream 308 to produce an ammonia gas 312.

System 300 further includes ammonia cracker reactor 314 for receiving ammonia gas 312 and a high-temperature fuel gas stream 315 as discussed below. Ammonia cracker reactor 314 is in geographical proximity to a combined cycle power facility 378 (i.e., an ammonia-fueled gas turbine power plant) (see FIG. 3B). The geographical proximity is similar to that discussed above for ammonia-fueled gas turbine power plant 110 in geographical proximity to ammonia cracker reactor 106 with regard to FIG. 1. High-temperature fuel gas stream 315 enters ammonia cracker reactor 314 as a heat source for partial cracking of ammonia gas 312 into hydrogen and nitrogen to generate heated product gas effluent 306 composed of ammonia, hydrogen and optionally nitrogen. Heated product gas effluent 306 can be formed using similar cracking catalysts and cracking conditions as discussed above. The partial cracking of ammonia gas 312 is incomplete such that only a portion of the ammonia gas entering ammonia cracker reactor 314 is cracked into hydrogen and nitrogen. The particular blends formed by the partial cracking of ammonia gas 312 can vary widely depending on the cracking catalyst, reaction conditions, ammonia cracker reactor, etc.

Accordingly, in order to meet the desired specifications for a product gas stream 360 composed of ammonia, hydrogen and optionally nitrogen to be passed to an ammonia-fueled gas turbine 362 to generate sufficient power to operate combined cycle power facility 378, it may be necessary to modify the amounts of ammonia and hydrogen present in heated product gas effluent 306. This is accomplished by the non-limiting illustrative embodiments described herein for system 300 for integrating partial ammonia cracking with low carbon power generation in a combined cycle power facility.

In some embodiments, high-temperature fuel gas stream 315 can be at a temperature ranging from about 1500° C. to about 1600° C. In some embodiments, high-temperature fuel gas stream 315 can be composed of nitrogen, oxygen, and water.

Following the partial cracking of ammonia gas 312, a fuel gas stream (not shown) can exit ammonia cracker reactor 314 at a temperature lower than high-temperature fuel gas stream 315, e.g., at a temperature ranging from about 950° C. to about 1000° C. This fuel gas stream can further provide heating to, for example, an ammonia vaporizer 356 or a separation unit 338 as discussed below.

Ammonia-fueled gas turbine 362 can be any suitable gas turbine fueled by ammonia for a combined cycle power plant. In an illustrative embodiment, FIG. 3B shows an example of ammonia-fueled gas turbine 362 for use in system 300. Ammonia-fueled gas turbine 362 includes a compressor 366 for compressing an oxidizing agent stream 364 to send a compressed oxidizing agent stream 368 to a combustion unit 370. Oxidizing agent stream 364 can be any suitable oxidizing source for combusting a product gas stream 360 as discussed below. In an illustrative embodiment, the oxidizing source can be air, oxygen, or oxygen diluted with carbon dioxide (i.e., an oxygen enriched source).

In some embodiments, compressor 366 includes a compressor rotor that rotates with a rotor axis as a center, a compressor casing that covers the compressor rotor, and an intake air amount regulator provided in a suction port of the compressor casing. The intake air amount regulator regulates the flow rate of air that is sucked into compressor 366 casing according to an instruction from a control device. In some embodiments, compressor 366 is, for example, an axial-flow compressor that includes moving blades and stationary blades which are disposed alternately in multiple stages along a rotating shaft, and pressurizes air taken from the atmosphere to a predetermined pressure and supplies it to the combustor. The rotating shaft of compressor 366 can be axially coupled to a rotating shaft of a turbine 374 and is rotated by turbine 374.

Ammonia-fueled gas turbine 362 includes combustion unit 370 for combusting product gas stream 360 using compressed oxidizing agent stream 368. Product gas stream 360 can be composed of a blend of hydrogen and ammonia as a fuel for operating ammonia-fueled gas turbine 362 to generate power to operate combined cycle power facility 378 as discussed below. Combustion unit 370 can be any combustion unit wherein a source of ammonia and hydrogen can be combusted with an oxidizing agent. For example, combustion unit 370 can be a fired heater or boiler used in power plants. In operation, combustion unit 370 can have burner that injects compressed oxidizing agent stream 368 supplied from compressor 366 and product gas stream 360 as a fuel into a chamber, and combusts product gas stream 360 using compressed oxidizing agent stream 368 as an oxidant.

Combustion unit 370 then supplies turbine 374 with a high-temperature and high-pressure combustion gas 372 (referred to combustion gas 372) as generated through a combustion reaction of product gas stream 360 as a driving fluid to generate an energy source 376 for providing power to combined cycle power facility 378 (i.e., an ammonia-fueled gas turbine power plant).

In some embodiments, turbine 374 has a turbine rotor that rotates with the rotor axis as a center by means of combustion gas 372 from combustion unit 370, and a turbine casing that covers the turbine rotor. The turbine rotor and the compressor rotor can be connected to each other to be rotatable with the same rotor axis as a center to form a gas turbine rotor. For example, a rotor of a generator is connected to the gas turbine rotor.

In some embodiments, turbine 374 can be, for example, an axial-flow turbine that includes moving blades and stationary blades which are disposed alternately in multiple stages along a rotating shaft, and is a prime mover that converts kinetic energy of the combustion gas (driving fluid) into power In some embodiments, the turbine rotates compressor 366 to which the rotating shaft is axially coupled by the power generated by turbine 374 itself. Also, turbine 374 can include an output shaft that is connected to a load and rotates the load.

Combined cycle power facility 378 produces electricity utilizing energy source 376 from ammonia-fueled gas turbine 362 to drive, for example, electricity generators. Ammonia-fueled gas turbine 362 also produces exhaust gas stream 380 having a temperature of about 800° C. to about 900° C.

In order to remove exhaust gas stream 380 from system 300, it may be necessary to cool exhaust gas stream 380 to a sufficient temperature such as room temperature. In some embodiments, exhaust gas stream 380 is cooled by sending exhaust gas stream 380 to a heat recovery steam generator (HRSG) 382 to act as a heat source. Heat recovery steam generator 382 is used to generate steam at various levels to drive for example, a high pressure (HP) steam turbine 384, an intermediate pressure (IP) steam turbine 390 and a low pressure (LP) steam turbine 398.

In operation, steam is produced in HRSG 382 from a boiler feed water 381 at three pressure levels illustrated as a HP steam 383, an IP steam 388 and a LP steam 394 to produce work in HP steam turbine 384 and mechanically attached to IP steam turbine 390 and LP steam turbine 398 to drive a generator (not shown). A steam 386 exhausted from HP steam turbine 384 at an intermediate pressure can flow through a one-way valve to a reheater cold header and through to discharge hot header. IP steam 388 flows to IP steam turbine 390 in normal operation and then flows into LP steam turbine 398 with LP steam 394 as a steam 396. An LP steam condensate 399 exits LP steam turbine 398 into HRSG 382 where it then exits as an LP steam condensate 395. Exhaust gas stream 397 then exits HRSG 382 at a temperature sufficient to be removed from system 300.

Turning back to FIG. 3A, as discussed above, first cooled product gas effluent 318 exits heat exchanger 304 and is then passed to a heat exchanger 320 to further reduce the temperature of first cooled product gas effluent 318. Heat exchanger 320 can be any suitable heat exchanger for further cooling first cooled product gas effluent 318 such as heat exchanger 220 discussed above to further cool first cooled product gas effluent 318 to provide a second cooled product gas effluent 322.

Second cooled product gas effluent 322 comprising hydrogen, ammonia and optionally nitrogen is then passed to a water wash column 324. Water wash column 324 is configured to remove unreacted ammonia gas from the dry gas mixture by using, for example, a pressurized water stream 326, to generate an ammonia-enriched effluent 328 composed of ammonia and water and a hydrogen-enriched gas effluent 330 composed of hydrogen and optionally nitrogen. In some embodiments, pressurized water stream 326 can be sourced from a boiler feed water. As ammonia is very soluble in water, water wash column 324 can be designed to reduce the ammonia content in hydrogen-enriched gas effluent 330 to a level below, for example, 100 ppm, or below 20 ppm and allow feeding hydrogen-enriched gas effluent 330 comprised of hydrogen and optionally nitrogen to a pressure swing adsorption (PSA) unit 344.

In some embodiments, PSA unit 344 can include one or more adsorption beds for separating hydrogen from hydrogen-enriched gas effluent 330 to generate a high-purity hydrogen gas 350 having a purity of greater than about 95% and a PSA tail gas 346. In some embodiments, high-purity hydrogen gas 350 can have a nitrogen content of about 0.01 vol. % to about 5 vol. %. In some embodiments, PSA unit 344 can include an adsorbent material comprising carbon, silica, zeolites, metal organic frameworks, or combinations thereof. The working principle of a PSA unit such as PSA unit 344 may be understood as follows: PSA comprises a physical separation process that allows small molecules, e.g., hydrogen, to pass through while trapping larger molecules (the adsorbate).

System 300 further includes a flash unit 332 for receiving ammonia-enriched effluent 328 from water wash column 324. Flash unit 332 is configured to purge flash gas from ammonia-enriched effluent 328 to provide an ammonia-enriched liquid 334 composed of ammonia and water, and a flash gas stream 336.

System 300 further includes a separation unit 338 for separating the ammonia from water in ammonia-enriched liquid 334. In some embodiments, separation unit 338 can be a distillation unit configured to carry out a process of separating ammonia from water based on differences in their boiling temperatures. For example, the distillation unit can heat ammonia-enriched liquid 334 to a temperature sufficient to vaporize the ammonia in ammonia-enriched liquid 334 to generate an ammonia gas stream 342 and a water stream 340. In some embodiments, water stream 340 can be sent to a cooling tower or recycled back to system 300.

In some embodiments, ammonia gas stream 342 can be combined with flash gas stream 336 and PSA tail gas 346 to form a fuel gas 348. In some embodiments, fuel gas 348 can be passed to a heater 349 with combustion air (not shown) to generate high-temperature fuel gas stream 315 that can be used as a heat source in system 300 as discussed above.

System 300 further includes a pump 352 for increasing the pressure of second ammonia feed stream 301-2. Pump 352 can be any suitable pump as discussed above for pump 250 for increasing the pressure of second ammonia feed stream 301-2 for sending a pressurized second ammonia feed stream 354 to an ammonia vaporizer 356.

System 300 further includes ammonia vaporizer 356 for receiving pressurized second ammonia feed stream 354. Ammonia vaporizer 356 can be any suitable ammonia vaporizer that can vaporize pressurized second ammonia feed stream 354 to produce an ammonia gas 358. For example, ammonia vaporizer 356 may mix pressurized second ammonia feed stream 354 with high-temperature fuel gas stream 315 and vaporize pressurized second ammonia feed stream 354 to generate ammonia gas 358.

Ammonia gas 358 is thereafter combined with high-purity hydrogen gas 350 to form a product gas stream 360 for sending to ammonia-fueled gas turbine 362. As discussed above, in order to meet the desired specifications for product gas stream 360 composed of ammonia, hydrogen and optionally nitrogen to be passed to ammonia-fueled gas turbine 362 to generate sufficient power to operate combined cycle power facility 378 (see FIG. 3B), it may be necessary to modify the amounts of ammonia and hydrogen present in heated product gas effluent 306 generated in ammonia cracker reactor 314.

Accordingly, the amount of ammonia gas 358 and high-purity hydrogen gas 350 will vary such that product gas stream 360 will meet the desired specifications for product gas stream 360 to be passed to ammonia-fueled gas turbine 362 to generate sufficient power to operate combined cycle power facility 378. In some embodiments, product gas stream 360 can contain from about 25 vol. % to about 50 vol. % hydrogen and from about 50 vol. % to about 75 vol. % ammonia. In some embodiments, product gas stream 360 can contain from about 30 vol. % to about 50 vol. % hydrogen and from about 50 vol. % to about 70 vol. % ammonia. In some embodiments, product gas stream 360 can contain about 30 vol. % hydrogen and about 70 vol. % ammonia. In some embodiments, product gas stream 360 can contain from about 5 vol. % to about 10 vol. % nitrogen. In some embodiments, product gas stream 360 can contain no nitrogen.

The following illustrative examples are intended to be non-limiting.

### Example 1

A partial ammonia cracking plant is illustrated via a process simulation of a partial ammonia cracker integrated with a combined cycle power plant.

In this example, the power plant is operated in a combined cycle mode, meaning the gas turbine and a steam turbine generate the power. A 30 vol % H₂/70 vol % NH₃ product stream is generated and fed in the gas phase to an air-blown, gas combustion turbine. A heat-recovery steam generator (HRSG) is installed downstream of the gas turbine exhaust which is capable of producing high-pressure (HP), medium pressure (MP), and low pressure (LP) steam. Each pressure level of steam is fed to a steam turbine to generate more power, with the exhaust pressure cascading down to the next pressure. The exhaust from the HP steam turbine is reheated in the HRSG before it is sent to the inlet of the MP turbine. The HRSG is also designed to preheat all of the boil feed water (BFW) needed by the power plant. Table 1 shows the operating conditions of the partial ammonia cracking plant.

TABLE 1

| | |
|---|---|
| Total Ammonia Import (tonne/day) | 3000 |
| Ammonia to Cracker (tonne/day | 810 |
| Ammonia to Product Blend (tonne/day) | 2070 |
| Ammonia to Combustion (tonne/day) | 120 |
| Cracking Pressure (barg) | 24.3 |
| Cracking Temperature (° C.) | 600 |
| Ammonia Conversion (%) | 88 |
| Hydrogen Recovery from PSA (%) | 85 |
| Product (vol. % H₂/NH₃/N₂) | 30/70/0 |
| Product Rate (tonne/day) | 2177 |
| Product LHV (kJ/kg) | 23,610 |
| Flue Gas Stack Temperature (° C.) | 189 |
| Flue Gas NO₂ (ppm, mass) | 2 |
| Total Power Consumption (MW) | 3.6 |

### Example 2

A partial ammonia cracking plant is illustrated via a process simulation of a partial ammonia cracker integrated with a combined cycle power plant discussed above in Example 1. Table 2 shows the performance and operating conditions of the combined cycle power plant. Based on an original ammonia import rate of 3000 tonne/day, the plant produces a net 249 MW power (91 MW from gas turbine, 164 MW from steam turbines).

TABLE 2

| | |
|---|---|
| Combustion Air Rate (tonne/day) | 43,970 |
| Fuel Rate (tonne/day) | 2,100 |
| Residual O₂ Content (mol %) in Flue Gas | 11.9 |
| Air Pressure (barg) | 20 |
| Gas Turbine Temperature, Inlet/Outlet (° C.) | 1351/823 |
| Gas Turbine Pressure, Inlet/Outlet (barg) | 20/0.8 |
| HP Steam Turbine Temperature, Inlet/Outlet (° C.) | 538/332 |
| HP Steam Turbine Pressure, Inlet/Outlet (barg) | 126/25 |
| MP Steam Turbine Temperature, Inlet/Outlet (° C.) | 538/327 |
| MP Steam Turbine Pressure, Inlet/Outlet (barg) | 25/3 |
| LP Steam Turbine Temperature, Inlet/Outlet (° C.) | 328/24 |
| LP Steam Turbine Pressure, Inlet/Outlet (barg) | 3/−0.98 |
| Gas Turbine Power Out (MW) | 373.5 |
| Air Compressor Power (MW) | 283 |
| HP/MP/LP Steam Power Out (MW) | 35/42/88 |
| Power consumption from NH₃ cracker (MW) | 3.6 |
| Net Power Generation (MW) | 249 |
| Thermal Efficiency, LHV (%, based on input to Ammonia Cracker) | 38.6 |
| Thermal Efficiency, LHV (%, based on input to Power Plant) | 41.9 |
| NO₂ Emissions, Flue Gas Stack (ppm, mass) | 35 |
| Flue Gas Stack Temperature (° C.) | 76 |

### Example 3

A partial ammonia cracking plant is illustrated via a process simulation of a partial ammonia cracker integrated with a simple cycle power plant.

In this example, the power plant is operated in a simple cycle mode, meaning only the gas turbine generates the power. Because of the significant waste heat available, heat integration between the power plant and the cracking plant is implemented. In reducing the fuel requirements needed for the cracker, additional ammonia flow and hydrogen flow (in the form of recompressed PSA tail gas) may be used as feedstock for the power plant. The residual nitrogen from the PSA tail gas is inert such that in the case of power generation it is not as detrimental since the gas turbine will be fired with air. The gas turbine exhaust is used to service the largest heat duties of the ammonia cracking plant: cracking reactor and NH₃ product vaporizer. Further heat integration is possible but adding too many heat exchangers along the path of the gas turbine exhaust will introduce a higher pressure drop thereby resulting in reduced power output. For this reason, the ammonia cracker plant has a small heater fired with a slipstream of the PSA tail gas and the off gas from ammonia recovery. The heater can serve smaller energy users such as the ammonia feed preheat and ammonia distillation column reboiler. Table 3 shows the operating conditions of the simple cycle design.

TABLE 3

| | |
|---|---|
| Total Ammonia Import (tonne/day) | 3000 |
| Ammonia to Cracker (tonne/day | 840 |
| Ammonia to Product Blend (tonne/day) | 2160 |
| Ammonia to Combustion (tonne/day) | 0 |
| Cracking Pressure (barg) | 24.3 |
| Cracking Temperature (° C.) | 600 |
| Ammonia Conversion (%) | 88 |
| Hydrogen Recovery from PSA (%) | 85 |
| Product (vol. % H₂/NH₃/N₂) | 29.5/63.9/6.6 |
| Product Rate (tonne/day) | 2770 |
| Product LHV (kJ/kg) | 24,410 |
| Flue Gas Stack Temperature (° C.) | 126 |
| Flue Gas NO₂ (ppm, mass) | 1.4 |
| Total Power Consumption (MW) | 3.6 |

Table 4 shows the performance of the simple cycle design. For a 3000 tonne/day ammonia import rate, the simple cycle produces 116 MW, which is less than half of that of the combined cycle case. Despite the lower power output, the simple design has the advantage of not requiring the use of steam turbines along with infrastructure to produce and manage steam.

TABLE 4

| | |
|---|---|
| Combustion Air Rate (tonne/day) | 43,970 |
| Fuel Rate (tonne/day) | 2,770 |
| Residual O₂ Content (mol %) in Flue Gas | 10.9 |
| Air Pressure (barg) | 20 |
| Gas Turbine Temperature, Inlet/Outlet (° C.) | 1414/859 |
| Gas Turbine Pressure, Inlet/Outlet (barg) | 20/0.7 |
| Gas Turbine Power Out (MW) | 403 |
| Air Compressor Power (MW) | 283 |
| HP/MP/LP Steam Power Out (MW) | 35/42/88 |
| Power consumption from NH₃ cracker (MW) | 3.6 |
| Net Power Generation (MW) | 116.2 |
| Thermal Efficiency, LHV (%, based on input to | 18 |
| Ammonia Cracker) | |
| Thermal Efficiency, LHV (%, based on input to | 17.6 |
| Power Plant) | |
| NO₂ Emissions, Flue Gas Stack (ppm, mass) | 36 |
| Flue Gas Stack Temperature (° C.) | 772 |

According to an aspect of the present disclosure, a process for generating power in an ammonia-fueled gas turbine power plant comprises:
flowing an ammonia feed stream to an ammonia cracker reactor in geographical proximity to an ammonia-fueled gas turbine power plant to crack ammonia feed stream under cracking conditions, thereby producing a product effluent comprising ammonia and hydrogen,
flowing the product effluent comprising ammonia and hydrogen to an ammonia-fueled gas turbine of an ammonia-fueled gas turbine power plant, and
combusting the product effluent comprising ammonia and hydrogen to drive the ammonia-fueled gas turbine,
wherein an exhaust stream generated from the ammonia-fueled gas turbine is recycled back to supply heat to the ammonia cracker reactor.

In non-limiting illustrative embodiments, as may be combined with one or more of the preceding paragraphs, the product effluent comprises from about 50 vol. % to about 75 vol. % ammonia and from about 25 vol. % to about 50 vol. % hydrogen.

In non-limiting illustrative embodiments, as may be combined with one or more of the preceding paragraphs, the product effluent comprises from about 50 vol. % to about 70 vol. % ammonia and from about 30 vol. % to about 50 vol. % hydrogen.

In non-limiting illustrative embodiments, as may be combined with one or more of the preceding paragraphs, the product effluent further comprises about 5 vol. % to about 10 vol. % nitrogen.

In non-limiting illustrative embodiments, as may be combined with one or more of the preceding paragraphs, the ammonia feed stream is a liquid ammonia feed stream, and the process further comprises flowing the liquid ammonia feed stream to a vaporizer to produce a vapor comprising ammonia gas, and flowing the vapor comprising ammonia gas to the ammonia cracker reactor.

In non-limiting illustrative embodiments, as may be combined with one or more of the preceding paragraphs, the cracking conditions comprises a temperature of about 450° C. to about 700° C., and a pressure of about 4 bar to about 40 bar.

In non-limiting illustrative embodiments, as may be combined with one or more of the preceding paragraphs, the ammonia-fueled gas turbine power plant is operated in one of a simple cycle mode or a combined cycle mode.

In non-limiting illustrative embodiments, as may be combined with one or more of the preceding paragraphs, the exhaust gas stream has a temperature of about 800° C. to about 900° C.

In non-limiting illustrative embodiments, as may be combined with one or more of the preceding paragraphs, the ammonia-fueled gas turbine generates an energy source for providing power to the ammonia-fueled gas turbine power plant.

In non-limiting illustrative embodiments, as may be combined with one or more of the preceding paragraphs, the ammonia-fueled gas turbine is a retrofitted natural gas turbine.

According to another aspect of the present disclosure, a process for generating power in an ammonia-fueled gas turbine power plant comprises:
flowing an ammonia gas feed stream to an ammonia cracker reactor in geographical proximity to an ammonia-fueled gas turbine power plant to crack ammonia feed stream under cracking conditions, thereby producing a product effluent comprising ammonia and hydrogen,
flowing a liquid ammonia feed stream to a vaporizer to produce a vapor comprising ammonia gas,
introducing the product effluent comprising ammonia and hydrogen into a water wash column, thereby producing a hydrogen-enriched gas effluent and an ammonia-enriched effluent comprising ammonia and water,
introducing the ammonia-enriched effluent into a distillation column, thereby producing a cleaned water wash stream and an ammonia gas,
introducing the hydrogen-enriched effluent to a pressure swing adsorption unit, thereby producing a high-purity hydrogen gas,
combining the vapor comprising ammonia gas, the ammonia gas and the high-purity hydrogen gas, thereby producing a product gas comprising from about 50 vol. % to about 75 vol. % ammonia gas and from about 25 vol. % to about 50 vol. % high-purity hydrogen gas, and
combusting the product gas in an ammonia-fueled gas turbine to drive the ammonia-fueled gas turbine for providing power to the ammonia-fueled gas turbine power plant.

In non-limiting illustrative embodiments, as may be combined with one or more of the preceding paragraphs, the cracking conditions comprises a temperature of about 450° C. to about 700° C., and a pressure of about 4 bar to about 40 bar.

In non-limiting illustrative embodiments, as may be combined with one or more of the preceding paragraphs, an exhaust stream generated from the ammonia-fueled gas turbine is recycled back to supply heat to the ammonia cracker reactor.

In non-limiting illustrative embodiments, as may be combined with one or more of the preceding paragraphs, the exhaust gas stream has a temperature of about 800° C. to about 900° C.

In non-limiting illustrative embodiments, as may be combined with one or more of the preceding paragraphs, the ammonia-fueled gas turbine is a retrofitted natural gas turbine.

In non-limiting illustrative embodiments, as may be combined with one or more of the preceding paragraphs, the ammonia-fueled gas turbine power plant is operated in one of a simple cycle mode or a combined cycle mode.

According to yet another aspect of the present disclosure, a system comprises:
an ammonia cracker reactor in geographical proximity to an ammonia-fueled gas turbine power plant configured to crack an ammonia feed stream under cracking conditions, thereby producing a product effluent comprising ammonia and hydrogen,
an ammonia-fueled gas turbine comprising a compressor, a combustor and a turbine of the ammonia-fueled gas turbine power plant and configured to combust the product effluent comprising ammonia and hydrogen and drive the ammonia-fueled gas turbine, and
a recycle line configured to flow an exhaust gas stream generated from the ammonia-fueled gas turbine back to supply heat to the ammonia cracker reactor.

In non-limiting illustrative embodiments, as may be combined with one or more of the preceding paragraphs, the product effluent comprises from about 50 vol. % to about 75 vol. % ammonia and from about 25 vol. % to about 50 vol. % hydrogen.

In non-limiting illustrative embodiments, as may be combined with one or more of the preceding paragraphs, the ammonia-fueled gas turbine power plant is operated in one of a simple cycle mode or a combined cycle mode.

In non-limiting illustrative embodiments, as may be combined with one or more of the preceding paragraphs, the exhaust gas stream has a temperature of about 800° C. to about 900° C.

In non-limiting illustrative embodiments, as may be combined with one or more of the preceding paragraphs, the ammonia-fueled gas turbine is a retrofitted natural gas turbine.

According to still yet another aspect of the present disclosure, a process for generating power in an ammonia-fueled gas turbine power plant comprises:
flowing an ammonia feed stream to an ammonia cracker reactor in geographical proximity to an ammonia-fueled gas turbine power plant to crack ammonia feed stream under cracking conditions, thereby producing a product effluent comprising ammonia and hydrogen,
flowing a liquid ammonia feed stream to a vaporizer to produce a vapor comprising ammonia gas,
introducing the product effluent comprising ammonia and hydrogen into a water wash column, thereby producing a hydrogen-enriched gas effluent and an ammonia-enriched effluent comprising ammonia and water,
introducing the hydrogen-enriched effluent to a pressure swing adsorption (PSA) unit, thereby producing a high-purity hydrogen gas and a PSA tail gas,
combining the vapor comprising ammonia gas and the high-purity hydrogen gas, thereby producing a product gas comprising from about 50 vol. % to about 75 vol. % ammonia gas and from about 25 vol. % to about 50 vol. % high-purity hydrogen gas, and
combusting the product gas in an ammonia-fueled gas turbine to drive the ammonia-fueled gas turbine for providing power to the ammonia-fueled gas turbine power plant.

In non-limiting illustrative embodiments, as may be combined with one or more of the preceding paragraphs, the process further comprises:
introducing the ammonia-enriched effluent into a flash unit, thereby producing a flash gas stream and an ammonia-enriched liquid comprising ammonia and water,
introducing the ammonia-enriched liquid into a distillation column, thereby producing a cleaned water wash stream and an ammonia gas, and
passing the ammonia gas, the PSA tail gas and the flash gas stream to the ammonia cracker reactor as a heat source for cracking the first ammonia gas feed stream.

In non-limiting illustrative embodiments, as may be combined with one or more of the preceding paragraphs, the cracking conditions comprises a temperature of about 450° C. to about 700° C., and a pressure of about 4 bar to about 40 bar.

In non-limiting illustrative embodiments, as may be combined with one or more of the preceding paragraphs, the ammonia-fueled gas turbine is a retrofitted natural gas turbine.

In non-limiting illustrative embodiments, as may be combined with one or more of the preceding paragraphs, the ammonia-fueled gas turbine power plant is operated in one of a simple cycle mode or a combined cycle mode.

According to still yet a further aspect of the present disclosure, a system comprises:
an ammonia cracker reactor in geographical proximity to an ammonia-fueled gas turbine power plant configured to crack an ammonia gas feed stream under cracking conditions, thereby producing a product effluent comprising ammonia and hydrogen,
a vaporizer configured to vaporize a liquid ammonia feed stream, thereby producing a vapor comprising ammonia gas,
a water wash column configured to wash the product effluent comprising ammonia and hydrogen into, thereby producing a hydrogen-enriched gas effluent and an ammonia-enriched effluent comprising ammonia and water,
a pressure swing adsorption (PSA) unit configured to produce a high-purity hydrogen gas and a PSA tail gas,
an ammonia-fueled gas turbine comprising a compressor, a combustor and a turbine of the ammonia-fueled gas turbine power plant and configured to combust a product gas comprising from about 50 vol. % to about 75 vol. % ammonia gas from the vapor comprising ammonia gas and from about 25 vol. % to about 50 vol. % high-purity hydrogen gas from the high-purity hydrogen gas and drive the ammonia-fueled gas turbine.

In non-limiting illustrative embodiments, as may be combined with one or more of the preceding paragraphs, the system further comprises:
a flash unit configured to produce a flash gas stream and an ammonia-enriched liquid comprising ammonia and water,
a distillation column configured to produce a cleaned water wash stream and an ammonia gas, and
a recycle line configured to recycle the ammonia gas, the PSA tail gas and the flash gas stream back to the ammonia cracker reactor as a heat source for cracking the ammonia gas feed stream.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the claims appended hereto.

What is claimed is:

1. A process for generating power in an ammonia-fueled gas turbine power plant, comprising:
flowing an ammonia feed stream to an ammonia cracker reactor in geographical proximity to an ammonia-fueled gas turbine power plant to crack ammonia feed stream under cracking conditions, thereby producing a product effluent comprising ammonia and hydrogen;
flowing the product effluent comprising ammonia and hydrogen to an ammonia-fueled gas turbine of an ammonia-fueled gas turbine power plant; and
combusting the product effluent comprising ammonia and hydrogen to drive the ammonia-fueled gas turbine;
wherein an exhaust stream generated from the ammonia-fueled gas turbine is recycled back to supply heat to the ammonia cracker reactor.

2. The process according to claim 1, wherein the product effluent comprises from about 50 vol. % to about 75 vol. % ammonia and from about 25 vol. % to about 50 vol. % hydrogen.

3. The process according to claim 1, wherein the product effluent comprises from about 50 vol. % to about 70 vol. % ammonia and from about 30 vol. % to about 50 vol. % hydrogen.

4. The process according to claim 1, wherein the product effluent further comprises about 5 vol. % to about 10 vol. % nitrogen.

5. The process according to claim 1, wherein the ammonia feed stream is a liquid ammonia feed stream, and the process further comprises flowing the liquid ammonia feed stream to a vaporizer to produce a vapor comprising ammonia gas, and flowing the vapor comprising ammonia gas to the ammonia cracker reactor.

6. The process according to claim 1, wherein the cracking conditions comprises a temperature of about 450° C. to about 700° C., and a pressure of about 4 bar to about 40 bar.

7. The process according to claim 1, wherein the ammonia-fueled gas turbine power plant is operated in one of a simple cycle mode or a combined cycle mode.

8. The process according to claim 1, wherein the exhaust gas stream has a temperature of about 800° C. to about 900° C.

9. The process according to claim 1, wherein the ammonia-fueled gas turbine generates an energy source for providing power to the ammonia-fueled gas turbine power plant.

10. The process according to claim 1, wherein the ammonia-fueled gas turbine is a retrofitted natural gas turbine.

11. A process for generating power in an ammonia-fueled gas turbine power plant, comprising:
flowing an ammonia gas feed stream to an ammonia cracker reactor in geographical proximity to an ammonia-fueled gas turbine power plant to crack ammonia feed stream under cracking conditions, thereby producing a product effluent comprising ammonia and hydrogen;
flowing a liquid ammonia feed stream to a vaporizer to produce a vapor comprising ammonia gas;
introducing the product effluent comprising ammonia and hydrogen into a water wash column, thereby producing a hydrogen-enriched gas effluent and an ammonia-enriched effluent comprising ammonia and water;
introducing the ammonia-enriched effluent into a distillation column, thereby producing a cleaned water wash stream and an ammonia gas;
introducing the hydrogen-enriched effluent to a pressure swing adsorption unit, thereby producing a high-purity hydrogen gas;
combining the vapor comprising ammonia gas, the ammonia gas and the high-purity hydrogen gas, thereby producing a product gas comprising from about 50 vol. % to about 75 vol. % ammonia gas and from about 25 vol. % to about 50 vol. % high-purity hydrogen gas; and
combusting the product gas in an ammonia-fueled gas turbine to drive the ammonia-fueled gas turbine for providing power to the ammonia-fueled gas turbine power plant.

12. The process according to claim 11, wherein the cracking conditions comprises a temperature of about 450° C. to about 700° C., and a pressure of about 4 bar to about 40 bar.

13. The process according to claim 11, wherein an exhaust stream generated from the ammonia-fueled gas turbine is recycled back to supply heat to the ammonia cracker reactor.

14. The process according to claim 13, wherein the exhaust gas stream has a temperature of about 800° C. to about 900° C.

15. The process according to claim 11, wherein the ammonia-fueled gas turbine is a retrofitted natural gas turbine.

16. A system, comprising:
an ammonia cracker reactor in geographical proximity to an ammonia-fueled gas turbine power plant configured to crack an ammonia feed stream under cracking conditions, thereby producing a product effluent comprising ammonia and hydrogen;
an ammonia-fueled gas turbine comprising a compressor, a combustor and a turbine of the ammonia-fueled gas turbine power plant and configured to combust the product effluent comprising ammonia and hydrogen and drive the ammonia-fueled gas turbine; and
a recycle line configured to flow an exhaust gas stream generated from the ammonia-fueled gas turbine back to supply heat to the ammonia cracker reactor.

17. The system according to claim 16, wherein the product effluent comprises from about 50 vol. % to about 75 vol. % ammonia and from about 25 vol. % to about 50 vol. % hydrogen.

18. The system according to claim 16, wherein the ammonia-fueled gas turbine power plant is operated in one of a simple cycle mode or a combined cycle mode.

19. The system according to claim 16, wherein the exhaust gas stream has a temperature of about 800° C. to about 900° C.

20. The system according to claim 16, wherein the ammonia-fueled gas turbine is a retrofitted natural gas turbine.
